(19) United States
(12) Patent Application Publication
(10) Pub. No.: US 2024/0412342 A1
(43) Pub. Date: Dec. 12, 2024

(54) NEURAL WAVEFRONT SHAPING FOR GUIDESTAR-FREE IMAGING THROUGH AN OBSCURANT

(71) Applicants: University of Maryland, College Park, College Park, MD (US); William Marsh Rice University, Houston, TX (US)

(72) Inventors: Christopher Allan Metzler, Washington, DC (US); Yushan Feng, Hyattsville, MD (US); Mingyang Xie, Hyattsville, MD (US); Ashok Veeraraghavan, Houston, TX (US); Haiyun Guo, Houston, TX (US); Vivek Boominathan, Houston, TX (US); Manoj K. Sharma, Troy, MI (US)

(21) Appl. No.: 18/737,264

(22) Filed: Jun. 7, 2024

Related U.S. Application Data
(60) Provisional application No. 63/641,516, filed on May 2, 2024.
(60) Provisional application No. 63/507,322, filed on Jun. 9, 2023.

(51) Int. Cl. G06T 5/80; G06T 5/50; G06T 5/60

(52) U.S. Cl. CPC G06T 5/80; G06T 5/50; G06T 5/60

(57) ABSTRACT

A system for imaging through an obscurant, includes a spatial light modulator (SLM) or a deformable mirror array (DMA) configured to modulate light, one or more sensors configured to capture an image, a processor, and a memory. The memory includes instructions stored thereon, which when executed by the processor cause the system to: incoherently illuminate a target by a light, the obscurant scatters the light creating an optical aberration; modulating the scattered light by the SLM or DMA; capture an image by the one or more sensors of the target as illuminated by the modulated light; generate a simulated image by a differential model; compare the captured image with the simulated image; estimate the target, the aberration, and a phase delay based on back-propagation of the comparison; and correct for the aberration based on at least one of the estimated target, the aberration, or the phase delay.

### CROSS-REFERENCE TO RELATED APPLICATIONS AND CLAIM OF PRIORITY

This application claims the benefit of, and priority to, U.S. Provisional Patent Application No. 63/641,516, filed on May 2, 2024, and U.S. Provisional Patent Application No. 63/507,322, filed on Jun. 9, 2023, the entire contents of which are hereby incorporated herein by reference.

### GOVERNMENT SUPPORT

This invention was made with government support under FA9550-22-1-0208 awarded by the Air Force Office of Scientific Research. The government has certain rights in the invention.

### TECHNICAL FIELD

The present disclosure relates generally to the field of computational imaging. More specifically, the present disclosure provides systems and methods for guidestar-free imaging through static and dynamic scattering media.

### BACKGROUND

Optical aberrations, such as turbulence and scattering, present a challenge for imaging. Dynamic objects present a challenge for existing image-guided adaptive optics and wavefront shaping methods. These methods estimate wavefront corrections using feedback provided by an image quality metric. If object movement causes this metric to change, it will provide an erroneous feedback signal, which can push the correction away from the truth.

Accordingly, there is interest in guidestar-free imaging through static and dynamic scattering media.

### SUMMARY

An aspect of the present disclosure provides a system for imaging through static and dynamic scattering media, including a spatial light modulator (SLM) or deformable mirror array (DMA) configured to modulate light, one or more sensors configured to capture an image, a processor, and a memory. The memory includes instructions stored thereon, which, when executed by the processor, cause the system to: incoherently illuminate a target by a light, the obscurant scatters the light creating an optical aberration; scatter the light by the optical aberration; modulate the scattered light by the SLM or DMA; capture an image, by the one or more sensors, of the target as illuminated by the modulated light; generate a simulated image by a differential model; compare the captured image with a simulated image; estimate the target, the aberration, and a phase delay based on back-propagation of the comparison; and correct for the aberration based on at least one of the estimated target, the aberration, or the phase delay.

In accordance with aspects of the disclosure, the differential model may include: a neural object representation configured to predict an intensity of the object and a neural aberration representation configured to predict the aberration.

In accordance with aspects of the disclosure, the instructions, when executed by the processor, may further cause the system to: predict the intensity of the object by the neural object representation by: predicting a displacement vector (Δx, Δy) by a first multilayer perceptron network based on a time-dependent observation (x, y, t); projecting a canonical space feature (x+Δx, y+Δy) on a neural texture map based on the displacement vector;

sampling the neural texture map at (x+Δx, y+Δy) to obtain a multi-dimensional vector representing the spatial feature of the canonical coordinate (x+Δx, y+Δy); and predict, by a second multilayer perceptron network, the intensity based on the multi-dimensional vector for each coordinate.

In accordance with aspects of the disclosure, the instructions, when executed by the processor, may further cause the system to: predict the aberration based on input coordinates (u, v, t) by: transforming spatial coordinates (u, v) with N_{Z} Zernike basis functions and then concatenated with t; and predicting the aberration by a third multilayer perceptron network based on the transformed input.

In accordance with aspects of the disclosure, the optical aberration may include a dynamic aberration.

In accordance with aspects of the disclosure, the modulation may include a modulation pattern predicted by a neural network.

In another aspect of the present disclosure, the instructions, when executed by the processor, may further cause the system to: optimize the modulation pattern based on a model parameterized by a neural network.

In another aspect of the present disclosure, the modulation may include a series of known and stochastically generated patterns.

In another aspect of the present disclosure, the modulation patterns on the SLM or the DMA are optimized to maximize imaging performance. In another aspect of the present disclosure, the optimized modulation patterns may be obtained by using a neural network.

In accordance with aspects of the disclosure, a computer-implemented method for imaging through an obscurant includes: capturing an image of a target by a sensor; incoherently illuminating a target by a light, the target including an obscurant that scatters the light creating an optical aberration; modulating the scattered light by a spatial light modulator (SLM) or a deformable mirror array (DMA) configured to modulate the light; capturing an image by the sensor of the target as illuminated by the modulated light; generating a simulated image by a differential model; comparing the captured image with the simulated image; estimating the target, aberration, and phase delay based on back-propagation of the comparison; and correcting for the aberration based on at least one of the estimated target, the aberration, or the phase delay.

In yet another aspect of the present disclosure, the differential model may include: a neural object representation configured to predict an intensity of the object; and a neural aberration representation configured to predict the aberration.

In another aspect of the present disclosure, the method may further include predicting the intensity of the object by the neural object representation by: predicting a displacement vector (Δx, Δy) by a first multilayer perceptron network based on a time-dependent observation (x, y, t); projecting a canonical space feature (x+Δx, y+Δy) on a neural texture map based on the displacement vector; sampling the neural texture map at (x+Δx, y+Δy) to obtain a multi-dimensional vector representing the spatial feature of the canonical coordinate (x+Δx, y+Δy); and predict, by a second multilayer perceptron network, the intensity based on the multi-dimensional vector for each coordinate.

In another aspect of the present disclosure, the method may further include predicting the aberration based on input coordinates (u, v, t) by transforming spatial coordinates (u, v) with N_{Z} Zernike basis functions and then concatenated with t; and predicting the aberration by a third multilayer perceptron network based on the transformed input.

In an aspect of the present disclosure, the optical aberration may include a dynamic aberration.

In an aspect of the present disclosure, the method may further include generating the modulation based on a series of known and stochastically generated patterns.

In an aspect of the present disclosure, the method may further include generating the modulation based on a modulation pattern predicted by a neural network.

In an aspect of the present disclosure, the method may further include optimizing the modulation pattern based on a model parameterized by a neural network.

In an aspect of the present disclosure, the modulation may include a random generation of patterns.

In accordance with further aspects of the present disclosure, a non-transitory computer-readable medium having stored thereon a program that, upon being executed by a processor, causes the processor to execute a computer-implemented method for imaging through an obscurant is presented. The method includes capturing an image of a target by a sensor; incoherently illuminating a target by a light, the target including an obscurant that scatters the light; modulating the scattered light by a spatial light modulator (SLM) or deformable mirror array (DMA) configured to modulate the light; capturing an image by the sensor of the target as illuminated by the modulated light; generating a simulated image by a differential model; comparing the captured image with the simulated image; estimating the target, aberration, and phase delay based on back-propagation of the comparison; and correcting for the aberration based on at least one of the estimated target, the aberration, or the phase delay.

Further details and aspects of exemplary embodiments of the present disclosure are described in more detail below with reference to the appended figures.

### BRIEF DESCRIPTION OF THE DRAWINGS

A better understanding of the features and advantages of the present disclosure will be obtained by reference to the following detailed description that sets forth illustrative embodiments, in which the principles of the present disclosure are utilized, and the accompanying drawings of which:

FIG. 1 is a diagram of an exemplary system for guidestar-free imaging through an obscurant, in accordance with examples of the present disclosure;

FIG. 2 is a block diagram of a controller configured for use with the system for of FIG. 1, in accordance with aspects of the disclosure;

FIG. 3 is a block diagram for the system of FIG. 1, in accordance with examples of the present disclosure;

FIG. 4 is a diagram of an exemplary neural aberration representation of the system of FIG. 1, in accordance with examples of the present disclosure;

FIG. 5 is a diagram of an exemplary neural object representation of the system of FIG. 1, in accordance with examples of the present disclosure;

FIG. 6 is a flow diagram of a method for guidestar-free imaging through an obscurant using the neural object representation of FIG. 5, in accordance with examples of the present disclosure;

FIG. 7 is a flow diagram of a method for predicting an intensity of an object using the system of FIG. 1, in accordance with examples of the present disclosure;

FIG. 8 is a flow diagram of a method for predicting the aberration using the neural aberration representation of FIG. 6, in accordance with examples of the present disclosure;

FIG. 9 is a set of examples learned modulations using the system of FIG. 1, in accordance with examples of the present disclosure;

FIG. 10 is a set of images of example scene reconstructions with random modulations and with learned modulations of the system of FIG. 1, in accordance with examples of the present disclosure;

FIG. 11 is a block diagram of an end-to-end learning framework for the system of FIG. 1, in accordance with examples of the present disclosure;

FIG. 12 is a set of images illustrating comparing uncorrected images, reconstruction with random modulations, reconstruction with learned modulations, and ground truth, using the system of FIG. 1, in accordance with examples of the present disclosure;

FIG. 13 is a set of images illustrating example modulation patterns and measurements, using the system of FIG. 1, in accordance with examples of the present disclosure;

FIG. 14 is a set of images illustrating object estimates and optical correction, using the system of FIG. 1, in accordance with examples of the present disclosure; and

FIG. 15 is a graph comparing neural wavefront shaping (NeuWS) implemented using the system of FIG. 1 and imaged-guided wave scattering (IGWS), in accordance with examples of the present disclosure.

### DETAILED DESCRIPTION

The present disclosure relates generally to the field of computational imaging. More specifically, the present disclosure provides systems and methods for guidestar-free imaging through an obscurant.

Although the present disclosure will be described in terms of specific examples, it will be readily apparent to those skilled in this art that various modifications, rearrangements, and substitutions may be made without departing from the spirit of the present disclosure. The scope of the present disclosure is defined by the claims appended hereto.

For purposes of promoting an understanding of the principles of the present disclosure, reference will now be made to exemplary embodiments illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

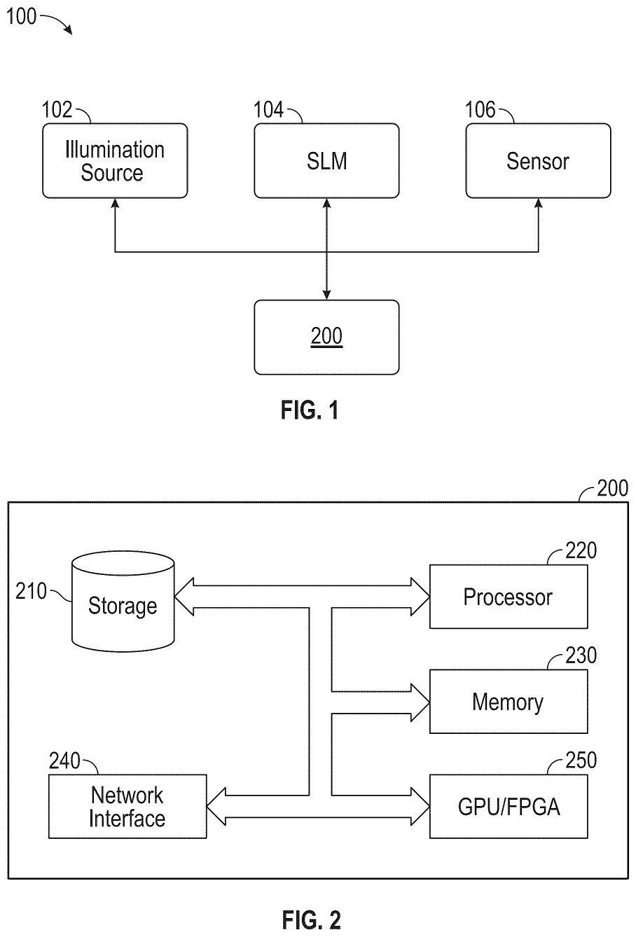

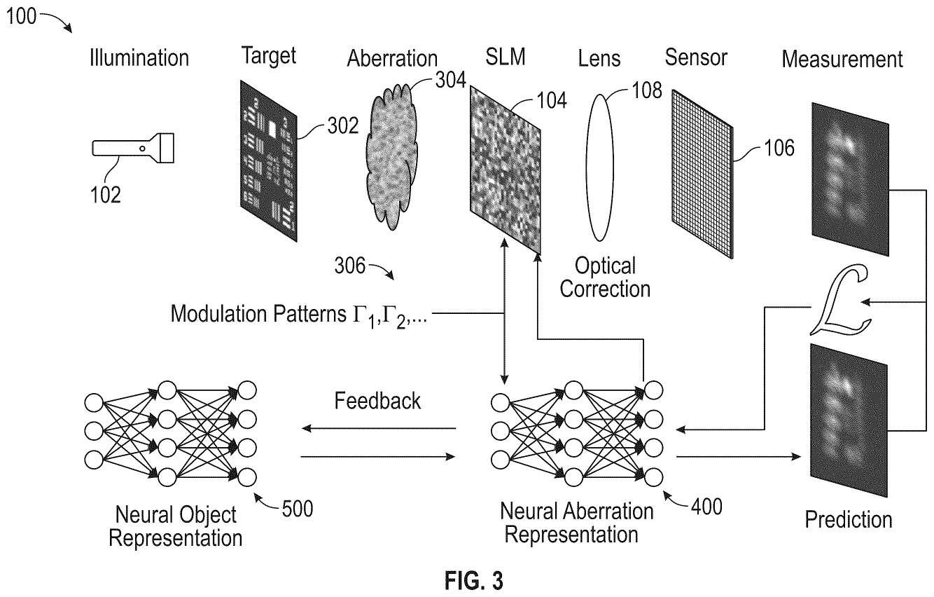

Referring to FIGS. 1-3, a system 100 for guidestar-free imaging through an obscurant (e.g., static and dynamic scattering media) is shown. The system 100 generally includes an illumination source 102, a spatial light modulator (SLM) 104 (or deformable mirror array (DMA)) configured to modulate light, a lens 108 configured to focus light, a sensor 106 configured to capture an image of a target 302 that includes an optical aberration 304 (FIG. 3), and a controller 200 (FIG. 2). The illumination source 102 is configured to incoherently illuminate the target 302 by a light. System 100 is configured to correct for the aberration 304 by using neural wavefront shaping (NeuWS) by estimating the target, the aberration, and a phase delay using back-propagation.

Imaging through scattering media presents a significant challenge across diverse scenarios, ranging from navigating with fog, rain, or murky water to recovering intricate structures through human skin and tissue. The core of this challenge is the irregular phase delays light experiences as it scatters. These phase delays blur and warp any images captured through the scattering media. Effectively addressing this issue will unlock new computer vision capabilities in fields such as medical imaging and astronomy. The disclosed system 100 provides the benefit of overcoming these challenges by providing high-resolution guidestar-free wavefront shaping through severe time-varying optical aberrations.

NeuWS combines an estimation-theory-based approach to wavefront shaping with time-varying neural representations to enable high-resolution guidestar-free wavefront shaping through severe time-varying optical aberrations. In doing so, NeuWS provides a breakthrough set of capabilities which significantly advances what is possible with adaptive optics (AO) and wavefront shaping.

NeuWS is a general-purpose approach to wavefront shaping. It can correct for lower-order optical aberrations like defocus as well as higher-order aberrations, like scattering. It is not restricted to imaging only binary, sparse, or simple scenes. Its maximum resolution is diffraction-limited by its aperture size and, like other wavefront shaping methods, in the presence of strong scattering it can, in theory, enhance contrast by up to:

$$η = {}_{4}^{Π} N$$

where N is the number of controlled pixels in the SLM or DMA. All optical wavefront shaping techniques are plagued by latency, which is in any dynamic system where there is some amount of mismatch between the wavefront that was measured (the past) and the wavefront the system is trying to optically correct (the present). As in-vivo aberration decorrelation times can be on the order of milliseconds, system latency represents a major barrier to optical wavefront shaping.

Unlike other wavefront shaping methods, NeuWS also estimates the aberration-free object. NeuWS can perform computational wavefront shaping post-capture. Because these corrections are performed post-capture on already collected data, NeuWS is able to sidestep any latency problems. The aberration that is computationally removed is an estimate of the aberration that was present when the measurements were captured. Thus, NeuWS can perform wavefront correction as quickly as it can modulate and capture images.

In the experiments, each image in the measurement sequences had an exposure time of about 90 ms to about 120 ms. Additionally, between each modulated frame an unmodulated frame was captured (they were not used during reconstruction and only served to visualize the aberrations). Thus, the experiments ran at roughly about 5 Hz. Assuming one is able to gather enough incoherent light, NeuWS's maximum frame rate is determined by the minimum of the SLM refresh rate and the camera frame rate. It is contemplated that the disclosed technology may be used to image through thick living tissue.

The proof-of-principle demonstrations were restricted to isoplanatic aberrations and planar scenes, which can be corrected with and put in focus by a single SLM pattern. In the context of imaging through scattering media, the isoplanatic aberration assumption corresponds to imaging within the memory effect region. NeuWS naturally extends to multi-planar aberration and object models, which may be corrected and imaged with multi-conjugate adaptive optics.

NeuWS is complementary to and may be used in conjunction with alternative scattering rejection/correction mechanisms, like two-photon microscopy, optical coherence tomography, and time-of-flight imaging.

A benefit of the disclosed NeuWS is that it can be easily extended to handle time-varying optical systems. To do so, one merely modifies the negative log-likelihood and neural representations to model time-varying measurements. The negative log-likelihood loss becomes, up to constants, proportional to:

$${ℒ}_{dyanmic} ( O ( {t}_{i} ) , Φ ( {t}_{i} ) ) = {\sum }_{i = 1}^{L} {‖ I ( {t}_{i} ) - O ( {t}_{i} ) * {\vert ℱ ( M ∘ {e}^{j ( Φ ( {t}_{i} ) + {Γ}_{i} )} ) \vert}^{2} ‖}^{2}$$

where I(tᵢ), O(tᵢ), and (tᵢ) are time-indexed representations of the image, object, and phase error. The neural representations of Φ and O similarly become −Φ(u, v, t): R3→[0, 2 π] and o(x, y, t): R³→R_{≥0}. Such representations, which treat the object and aberration as functions of both space and time, allow one to leverage temporal regularity in the data without having explicit models on the time-varying dynamics.

FIG. 2 illustrates controller 200 which includes a processor 220 connected to a computer-readable storage medium or a memory 230. The controller 200 may be used to control and/or execute operations of the system 100. The computer-readable storage medium or memory 230 may be a volatile type of memory, e.g., RAM, or a non-volatile type of memory, e.g., flash media, disk media, etc. In various aspects of the disclosure, the processor 220 may be another type of processor, such as a digital signal processor, a microprocessor, an ASIC, a graphics processing unit (GPU), a field-programmable gate array (FPGA) 250, or a central processing unit (CPU). In certain aspects of the disclosure, network inference may also be accomplished in systems that have weights implemented as memristors, chemically, or other inference calculations, as opposed to processors.

In aspects of the disclosure, the memory 230 can be random access memory, read-only memory, magnetic disk memory, solid-state memory, optical disc memory, and/or another type of memory. In some aspects of the disclosure, the memory 230 can be separate from the controller 200 and can communicate with the processor 220 through communication buses of a circuit board and/or through communication cables such as serial ATA cables or other types of cables. The memory 230 includes computer-readable instructions that are executable by the processor 220 to operate the controller 200. In other aspects of the disclosure, the controller 200 may include a network interface 240 to communicate with other computers or to a server. A storage device 210 may be used for storing data. The disclosed method may run on the controller 200 or on a user device, including, for example, on a mobile device, an IoT device, or a server system.

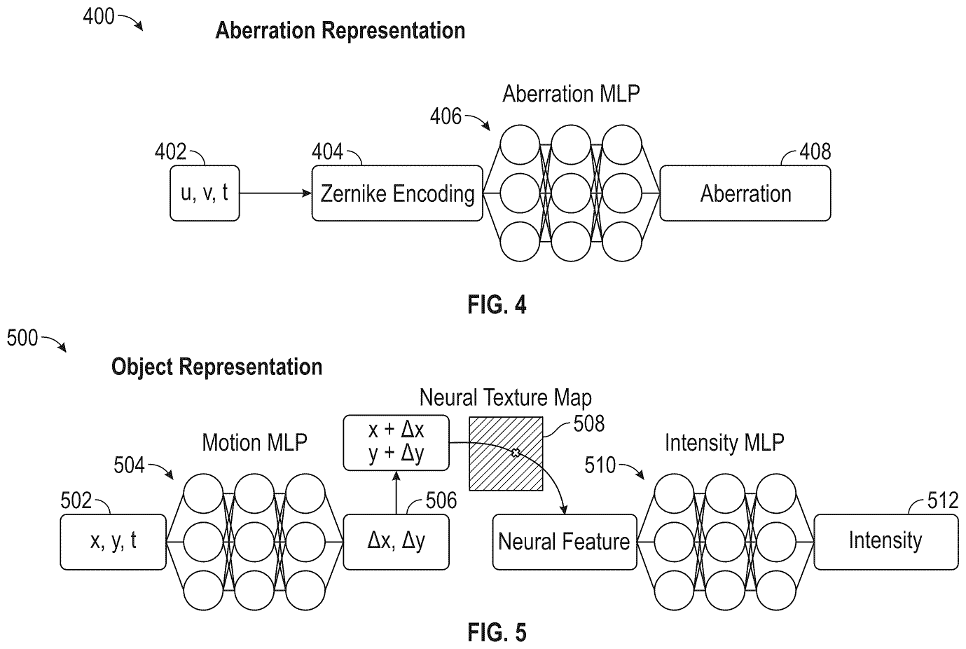

Referring to FIG. 4, a block diagram of a neural aberration representation 400 configured to predict the aberration 408 is shown. The neural aberration representation 400 generally includes a multilayer perceptron network 406 configured to predict the aberration Φ 408 at location (u, v) at time t. To encode the input coordinates (u, v, t) 402, the spatial coordinates (u, v) are transformed using N_{Z} Zernike basis functions 404 and then concatenated the output values with t. This output is then processed by the multilayer perceptron network 406 to predict the aberration Φ 408. For example, the multilayer perceptron network 406 may be an 8-layer MLP with a hidden dimension size of 32 and leaky ReLU activations that outputs small negative numbers if the inputs are negative.

Referring to FIG. 5, a block diagram of a neural object representation 500 configured to predict the intensity 512 of the object is shown. The neural object representation 500 generally includes a motion multilayer perceptron network 504 (i.e., a first multilayer perceptron network) and an intensity multilayer perceptron network 510 (i.e., a second multilayer perceptron network). The motion multilayer perceptron network 504 is configured to predict a displacement vector (Δx, Δy) 506 based on a time-dependent observation (x, y, t) 502. For example, the motion multilayer perceptron network 504 may include 3 layers with 32 hidden dimensions. For example, the intensity multilayer perceptron network 510 may include 3 layers with 32 hidden dimensions. The neural object representation 500 projects a canonical space feature (x+Δx, y+Δy) on a neural texture map 508 based on the displacement vector 506. The neural object representation 500 samples the neural texture map 508 at (x+Δx, y+Δy) to obtain a multi-dimensional vector representing the spatial feature of the canonical coordinate (x+Δx, y+Δy). The intensity multilayer perceptron network 510 predicts the intensity 512 based on the multi-dimensional vector for each coordinate.

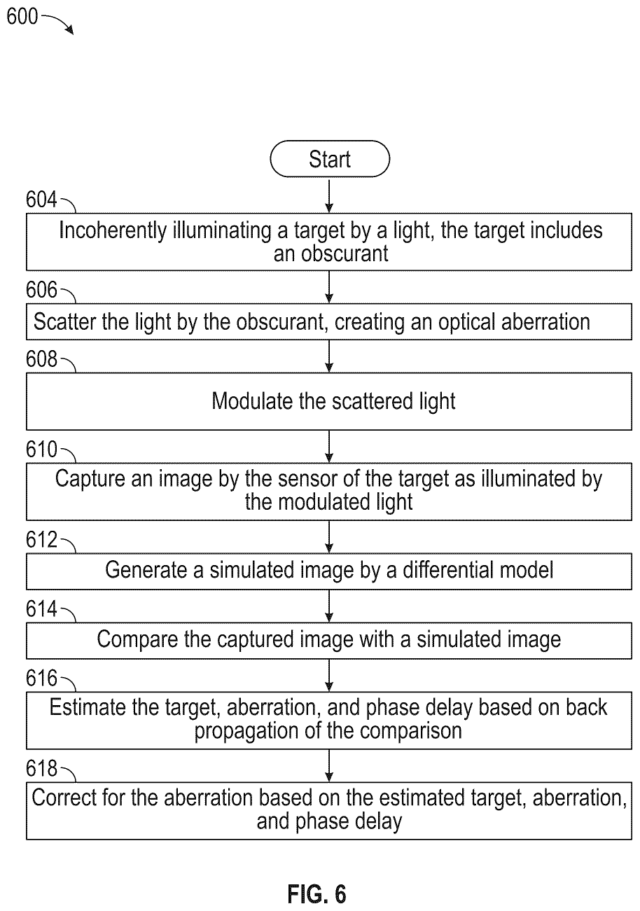

Referring to FIG. 6, a flow diagram for a method for imaging through an obscurant (for example, static and dynamic scattering media or turbulence) in accordance with the present disclosure is shown as 600. Although the steps of FIG. 6 are shown in a particular order, the steps need not all be performed in the specified order, and certain steps can be performed in another order. For example, FIG. 6 will be described below, with a controller 200 of FIG. 2 performing the operations. In aspects, the operations of FIG. 6 may be performed all or in part by another device, for example, a server, a mobile device, such as a smartphone, and/or a computer system. These variations are contemplated to be within the scope of the present disclosure.

Initially, at step 604, the processor causes the system 100 to incoherently illuminate a target 302 by a light projected by an illumination source 102 (FIG. 3). The target 302 includes an obscurant at an aperture plane of the target. The obscurant may be a static or a dynamic aberration. The obscurant may be unknown.

Next, at step 606, the light is scattered by the obscurant, creating an optical aberration 304. For example, the obscurant may include things such as fog, rain, murky water, human skin, and/or tissue.

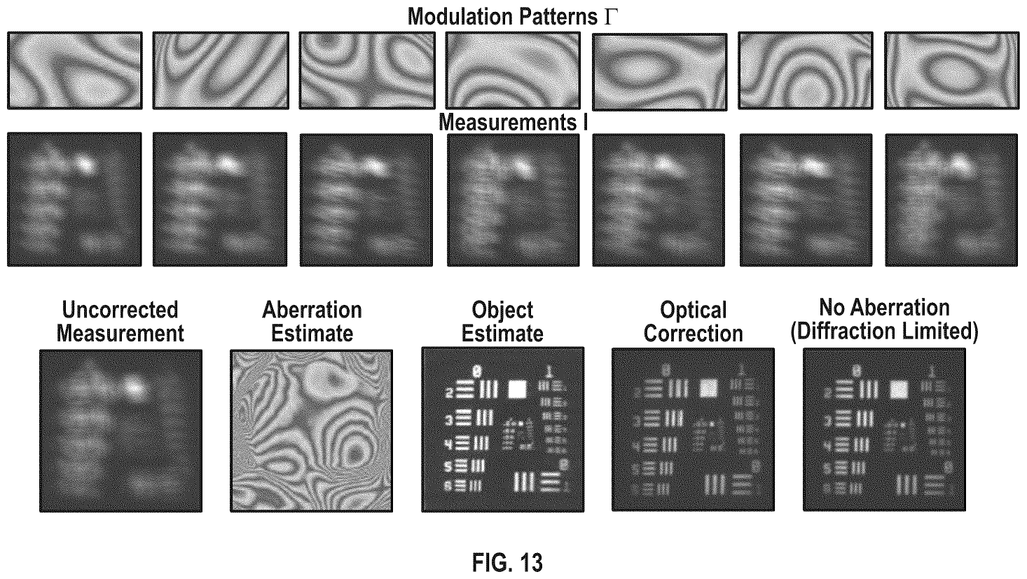

Next, at step 608, the processor causes the system 100 to modulate the light by the SLM 104 (or DMA). In aspects, the SLM 104 or DMA may be a phase-only SLM, a DMA array, a DMD device, and/or a phase SLM. The modulation may include a modulation pattern predicted by a neural network or a random generation of patterns. In aspects, the modulation may include a series of known and stochastically generated patterns (Γ₁, Γ₂, . . . Γ_{L}). In aspects, the system 100 may optimize the modulation pattern based on a model parameterized by the neural network. Example modulation patterns are shown in FIG. 13.

When the scattering media scrambles the incoming wavefront, it destroys some of the target's frequencies, either by destructively interfering with them or by scattering them outside the imaging sensor 106 (FIG. 1). If those frequencies are not captured in the measurement, it becomes difficult to faithfully recover them. The system 100 provides a technical solution to this problem by modulating the light by the SLM 104. For example, the system 100 may apply multiple modulations during acquisition to increase the chance that a frequency component is preserved.

The modulation patterns may be imaged onto the system's aperture plane using, for example, a 4f optical system. A 4f optical system is a configuration in optics that uses two lenses to perform Fourier transformation on an image.

Next, at step 610, the processor causes the system 100 to capture, by the sensor 106, image(s) of the target 302 as illuminated by the modulated light. For example, the image may include a plane (the object) in the sky, which may be obscured by clouds or haze. In another example, the image may include blood vessels (the object) which may be obscured by human tissue. The imaging sensor 106 may include any suitable sensor for the spectrum of light being used to illuminate the target, such as CMOS sensors and/or CCD sensors.

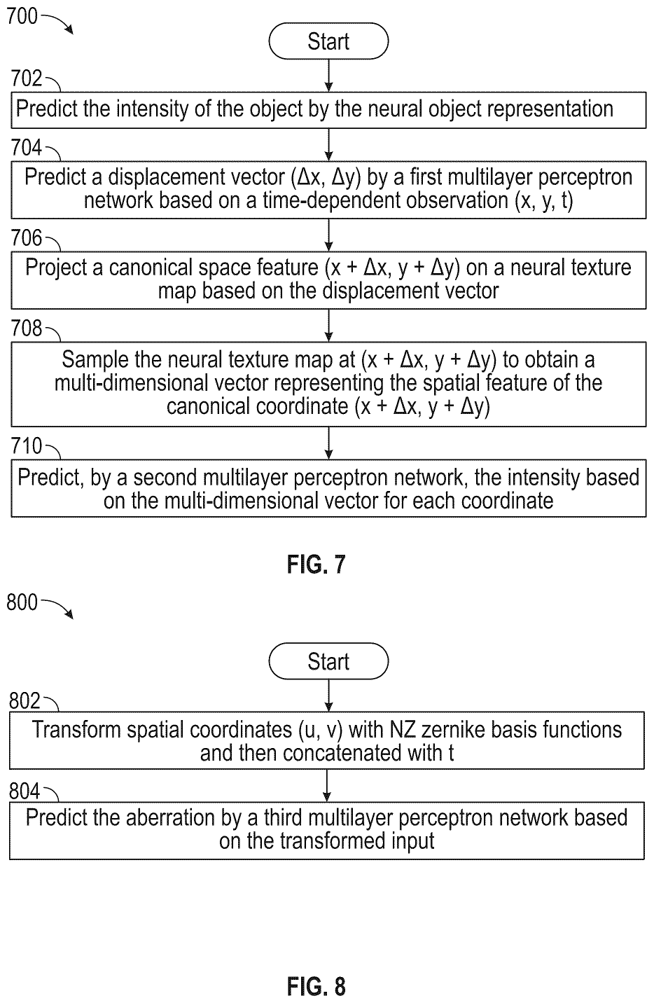

Next, at step 612, the processor causes the system 100 to generate a simulated image using a differential model. The differential model includes the neural aberration representation 400 (FIG. 4) and the neural object representation 500 (FIG. 5). The simulated image may include a predicted aberration and a predicted intensity of the object (FIG. 13). For a detailed description of the operation of the neural aberration representation 400 and the neural object representation 500 see FIGS. 7 and 8.

The system 100 regularizes and partially convexifies the estimation problem by parameterizing Φ and O as the output of two untrained coordinate-based neural networks:

Φ(u, v): R2→[0, 2 π] and o(x, y): R²→R_{≥0}.

These networks, which rely on no external training data, map 2D spatial coordinates (u, v) and (x, y) to estimates of the aberration and object brightness, respectively. One can form Φ and O by evaluating Φ and O at all (u, v) and (x, y) on a pixel grid. Φ and O can then be used to compute the loss from:

$${ℒ}_{static} ( O , Φ ) = {\sum }_{i = 1}^{L} {‖ {I}_{i} - O * {\vert ℱ ( M ∘ {e}^{j ( Φ + {Γ}_{i} )} ) \vert}^{2} ‖}^{2}$$

Next, at step 614, the processor causes the system 100 to compare the captured image with a simulated image.

Next, at step 616, the processor causes the system 100 to estimate the target 302, the aberration 408, and a phase delay based on back-propagation of the comparison.

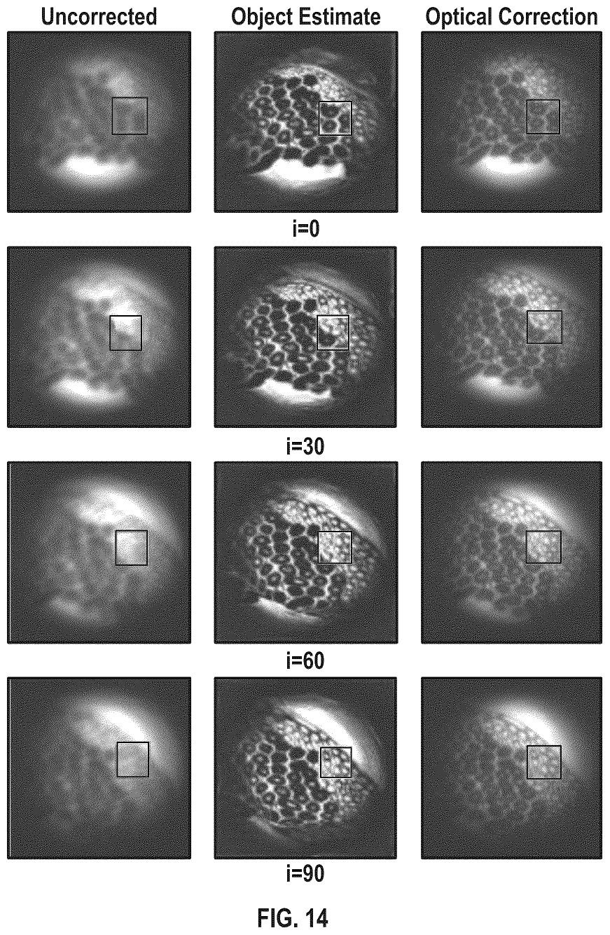

Next, at step 618, the processor causes the system 100 to correct (i.e., optical correction) for the aberration based on the estimated target 302, the aberration 408, and the phase delay (FIGS. 13 and 14). The corrected image may be displayed on a display or stored for later use.

Referring to FIG. 7, a flow diagram for a method for predicting the intensity of the object using the neural object representation 500 in accordance with the present disclosure is shown as 700. Although the steps of FIG. 7 are shown in a particular order, the steps need not all be performed in the specified order, and certain steps can be performed in another order. For example, FIG. 7 will be described below, with a controller 200 of FIG. 2 performing the operations. In aspects, the operations of FIG. 7 may be performed all or in part by another device, for example, a server, a mobile device, such as a smartphone, and/or a computer system. These variations are contemplated to be within the scope of the present disclosure.

Initially, at step 702, the processor causes the system 100 to predict a displacement vector (Δx, Δy) by the motion multilayer perceptron network 504 based on a time-dependent observation (x, y, t) (FIG. 5).

Next, at step 704, the processor causes the system 100 to project a canonical space feature (x+Δx, y+Δy) on a neural texture map based on the displacement vector. As used herein the term canonical includes standard basis vectors, i.e., sets of vectors on phase space.

Next, at step 706, the processor causes the system 100 to sample the neural texture map at (x+Δx, y+Δy) to obtain a multi-dimensional vector representing the spatial feature of the canonical coordinate (x+Δx, y+Δy).

Next, at step 708, the processor causes the system 100 to predict, by the intensity multilayer perceptron network 510, the intensity based on the multi-dimensional vector for each coordinate.

Referring to FIG. 8, a flow diagram for a method for predicting the aberration based on input coordinates (u, v, t) using the neural aberration representation 400 in accordance with the present disclosure is shown as 800. Although the steps of FIG. 8 are shown in a particular order, the steps need not all be performed in the specified order, and certain steps can be performed in another order. For example, FIG. 8 will be described below, with a controller 200 of FIG. 2 performing the operations. In aspects, the operations of FIG. 8 may be performed all or in part by another device, for example, a server, a mobile device, such as a smartphone, and/or a computer system. These variations are contemplated to be within the scope of the present disclosure.

Initially, at step 802, the processor causes the system 100 to transform spatial coordinates (u, v) with N_{Z} Zernike basis functions and then concatenated with t.

Next, at step 804, the processor causes the system 100 to predict the aberration by a multilayer perceptron network 406 based on the transformed input (FIG. 4).

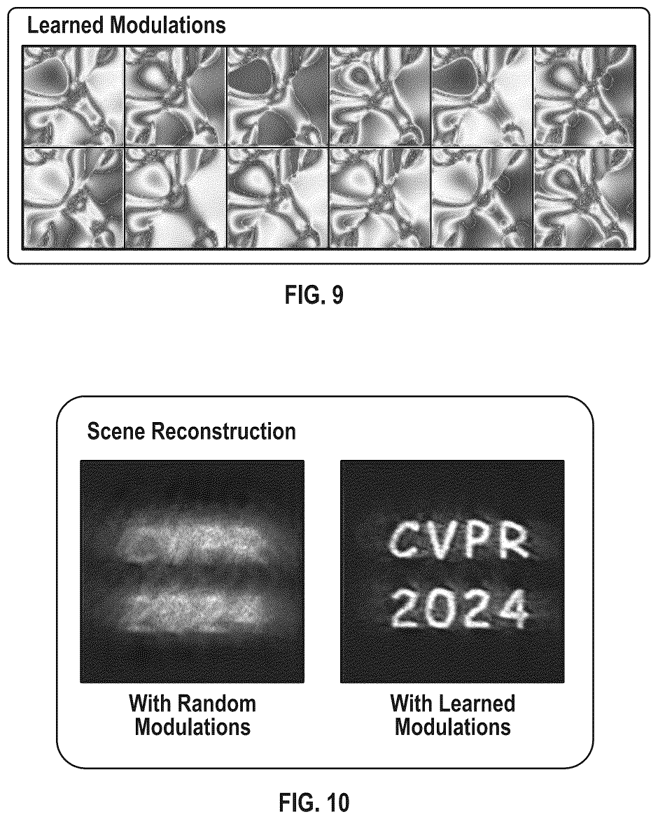

FIG. 9 is a set of images of example learned modulations using the system of FIG. 1. The disclosed system 100 leverages a differentiable proxy, P, of non-differentiable algorithms to design improved physical systems, specifically the phase modulation Γ={γᵢ}ᵢ₌₁^{K} used to image through scattering. A training image xₙ is sampled and simulated passing it through an optical aberration drawn from some known distribution while K learnable modulations are applied to the scattered wavefront. This model enables the simulation of a collection of K images

$${Y}_{𝓃}^{Γ} = \{ {y}_{1}^{𝓃} , {y}_{2}^{𝓃} , … {y}_{K}^{n} \} ,$$

which are different scattered observations of xn based on:

y=h(Ø)*x+ϵ,
where y is the captured measurement, x is the target scene to be reconstructed, e is noise, and h(ϕ) is the unknown, spatially invariant point spread function (PSF) describing the optical scattering, which manifests as unknown phase delays ϕ to the wavefront.

Both the proxy reconstruction algorithm P and the modulation patterns Γ are optimized to minimize:

$${ℒ}_{learned} ( 𝒫 , Γ ) = {\sum }_{n - 1}^{N} {‖ 𝒫 ( {Y}_{n}^{Γ} ) - {x}_{n} ‖}^{2} .$$

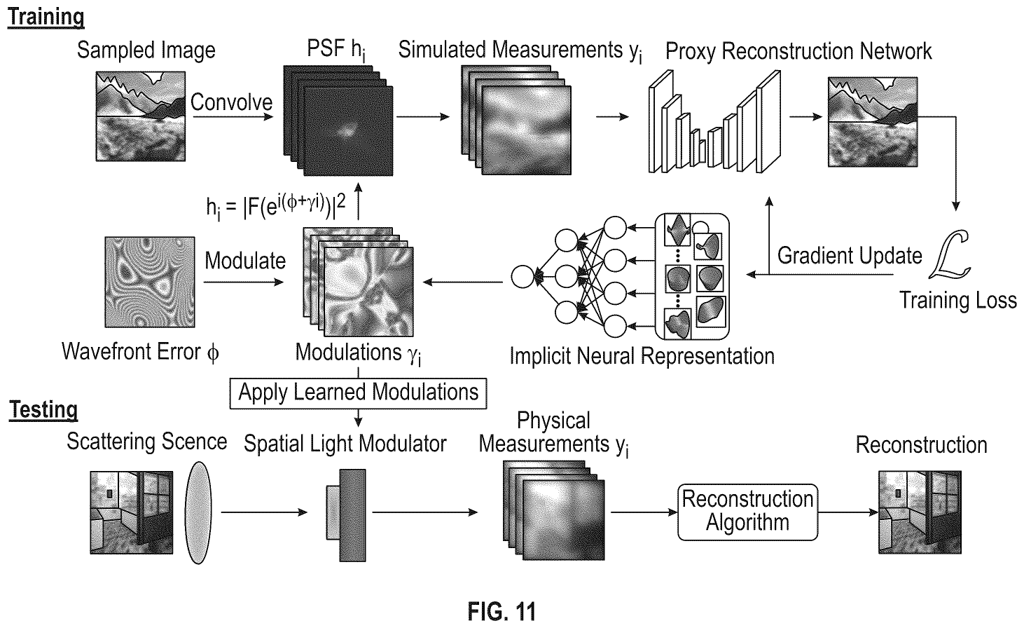

Note that the ultimate goal of the learning is not to design a set of modulations specific to the network P. Rather, the performance of P is used as a proxy to probe how effective the modulations Γ are for the scattering problem. The differentiability of P allows for back-propagation to guide the optimization of the modulations. While P itself may not generalize outside of its training data domain, the learned modulations Γ are compatible with other more generalizable reconstruction algorithms. The end-to-end training pipeline is illustrated in FIG. 11. For the proxy reconstruction network, for example, a UNet may be used with skip connections and self-attention modules.

To regularize the highly non-convex problem of optimizing modulations, an implicit neural representation is used for the modulations Γ. Specifically, the MLP G takes a fixed vector Z with 28 channels, which corresponds to the first twenty-eight Zernike polynomials; it outputs a 16-channel vector corresponding to 16 modulation patterns: Γ_{G}=G(Z).

Incorporating the implicit neural representation for the modulations, the final loss function becomes:

$${ℒ}_{final} ( 𝒫 , G ) = {\sum }_{n - 1}^{N} {‖ 𝒫 ( {Y}_{n}^{{Γ}_{G}} ) - {x}_{n} ‖}^{2} ,$$

where

$${Y}_{n}^{{Γ}_{G}} = {\{ h ( {ϕ}_{n} + {G ( Z )}_{i} ) * {x}_{n} \}}_{i = 1}^{K} .$$

After obtaining the learned modulations Γ_{G} and applying them during real-world acquisition, the scattered modulated measurements are sent to an unsupervised iterative optimization-based reconstruction algorithm which does not suffer from the generalization issue of data driven methods. In effect, the system 100 offers a best-of-both worlds scenario: the modulations Γ_{G} are effectively learned thanks to the joint supervised training with the proxy network P, but their enhanced data acquisition quality is transferrable to other reconstruction algorithms, thus benefiting from the generalization and domain adaptability of unsupervised reconstruction methods.

FIG. 10 is a set of images of example scene reconstructions with random modulations and with learned modulations using the system of FIG. 1.

FIG. 11 is a block diagram of an end-to-end learning framework for the system of FIG. 1. During training, the implicit neural representation for the wavefront modulations and the proxy reconstruction network are joint-optimized in an end-to-end fashion. During inference, one can apply the learned wavefront modulations to any reconstruction algorithms for imaging through scattering, either a trained feed-forward reconstruction network or an unsupervised iterative optimization algorithm. The former approach is far faster and performs better when test data and training data fall into similar distributions, while the latter generalizes better to unseen distributions of target scenes.

The approach employed by system 100 provides the benefit of better-preserving frequencies against scattering during image acquisition. System 100 combines the strengths of differentiable optimization and data-driven learning. The approach used by the system 100 is the novel integration of the optical model of wavefront modulations with a proxy reconstruction network, resulting in a fully differentiable system. This integration allows for the simultaneous optimization of both the proxy reconstruction network and the modulation patterns, which are optimized end-to-end based on a large, simulated training dataset. This proxy feedforward network enables the bypassing of the expensive back-propagation computation through an iterative reconstruction algorithm.

Learned modulations significantly enhance the reconstruction capability of the system 100. The end-to-end learning framework enables the optimization of acquisition-time wavefront modulations to enhance the ability to see through scattering. The learned modulations provide the benefit of substantially improving image reconstruction quality and effectively generalizing to unseen targets and scattering media. The learned modulations can be decoupled from the jointly trained proxy reconstruction network and significantly enhance the reconstruction quality of state-of-the-art unsupervised approaches.

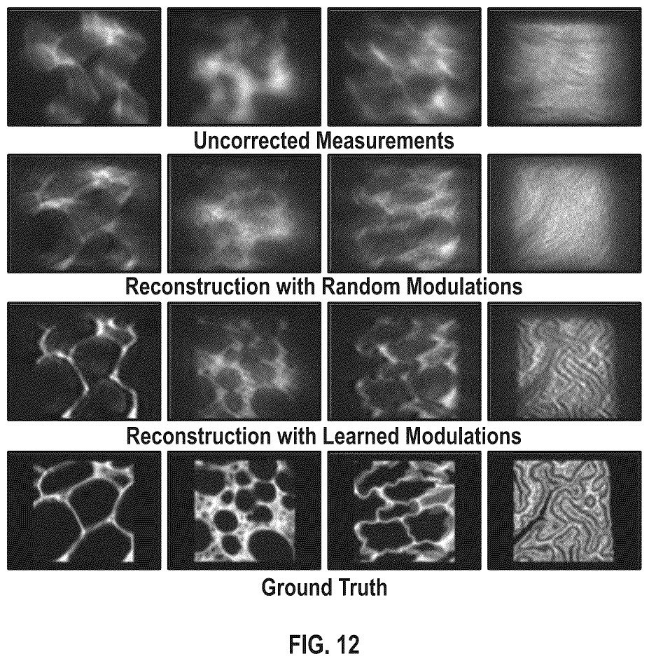

FIG. 12 is a set of images illustrating comparing uncorrected image reconstruction with both random modulations and reconstruction with learned modulations as performed by the system of FIG. 1.

FIG. 13 is a set of images illustrating example modulation patterns and measurements, using the system of FIG. 1. The example phase modulation patterns Γ displayed on the SLM 104 (FIG. 1), and the corresponding measurement each pattern produces (measurements I) are shown. The system 100 produces accurate digital reconstructions of the aberration (“Aberration Estimate”) and the object (“Object Estimate”) using, for example, thirty measurements. “Optical Correction” denotes an image captured with the conjugate of the aberration estimate displayed on the SLM 104. “No Aberration” denotes an image captured without an aberration along the optical path. “Uncorrected” denotes images captured through an unknown optical aberration.

FIG. 14 is a set of images illustrating object estimates and optical correction using the system of FIG. 1. The set of images shows the experimental results of imaging a rotating (i.e., moving) fish stamp through a 0.5° diffuser using varying numbers of modulated measurements (i). The time-varying log-likelihood loss was minimized, where the object O (but not the aberration Φ) was parameterized as a function of time to form estimates of O and Φ.

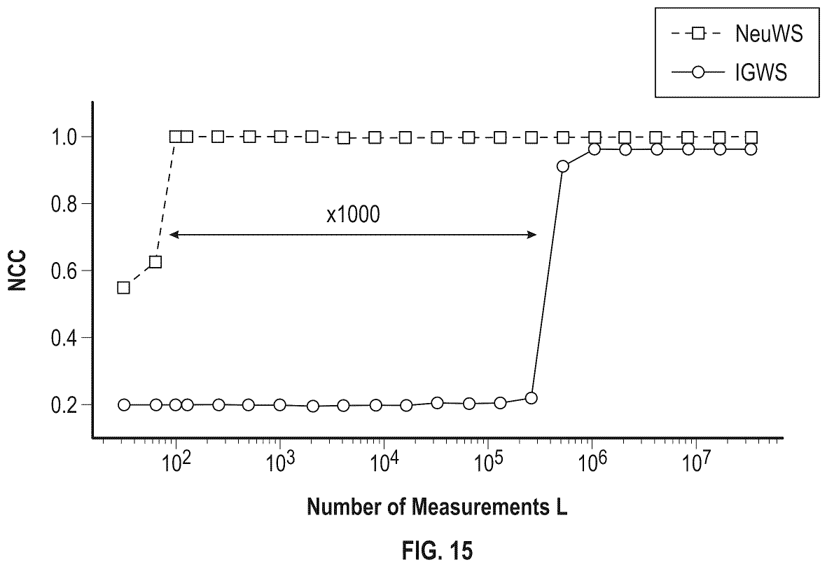

FIG. 15 is a graph illustrating the advantages of NeuWS implemented by system 100, and imaged-guided wave scattering (IGWS) is tasked with correcting for scattering-induced optical aberrations (simulated with complex circular Gaussian wavefront errors) using a varied number of total measurements. The reconstruction quality is measured by a normalized correlation coefficient (NCC) between the reconstruction and the target against the number of measurements used. The system of FIG. 1 provides the technical benefit of correcting for optical aberrations using orders of magnitude fewer measurements than IGWS.

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different example embodiments provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A system for imaging through an obscurant, the system comprising:
a spatial light modulator (SLM) or a deformable mirror array (DMA) configured to modulate light;
one or more sensors configured to capture an image;
a processor; and
a memory including instructions stored thereon which, when executed by the processor, cause the system to:
incoherently illuminate a target by a light, wherein the obscurant scatters the light creating an optical aberration;
modulate the scattered light by the SLM or DMA;
capture, by the one or more sensors, an image of the target as illuminated by the modulated light;
generate a simulated image by a differential model;
compare the captured image with the simulated image;
estimate the target, the aberration, and a phase delay based on back-propagation of the comparison; and
correct for the aberration based on at least one of the estimated target, the aberration, or the phase delay.

2. The system of claim 1, wherein the differential model includes:
a neural object representation configured to predict an intensity of the object; and
a neural aberration representation configured to predict the aberration.

3. The system of claim 2, wherein the instructions, when executed by the processor, further cause the system to:
predict the intensity of the object by the neural object representation by:
predicting a displacement vector (Δx, Δy) by a first multilayer perceptron network based on a time-dependent observation (x, y, t);
projecting a canonical space feature (x+Δx, y+Δy) on a neural texture map based on the displacement vector;
sampling the neural texture map at (x+Δx, y+Δy) to obtain a multi-dimensional vector representing the spatial feature of the canonical coordinate (x+Δx, y+Δy); and
predicting, by a second multilayer perceptron network, the intensity based on the multi-dimensional vector for each coordinate.

4. The system of claim 2, wherein the instructions, when executed by the processor, further cause the system to:
predict the aberration based on input coordinates (u, v, t) by:
transforming spatial coordinates (u, v) with N_{Z} Zernike basis functions and then concatenated with t; and
predicting the aberration by a third multilayer perceptron network based on the transformed input.

5. The system of claim 1, wherein the optical aberration includes a dynamic aberration.

6. The system of claim 1, wherein the modulation patterns on the SLM or the DMA are optimized to maximize imaging performance.

7. The system of claim 6 wherein the optimized modulation patterns are obtained by using a neural network.

8. The system of claim 6, wherein the instructions, when executed by the processor, further cause the system to:
optimize the modulation pattern based on a model parameterized by the neural network.

9. The system of claim 1, wherein the modulation includes a series of known and stochastically generated patterns.

10. The system of claim 1, wherein the modulation includes a random generation of patterns.

11. A computer-implemented method for imaging through an obscurant, the method comprising:
capturing an image of a target by one or more sensors;
incoherently illuminating a target by a light, wherein the obscurant scatters the light creating an optical aberration;
modulating the scattered light by a spatial light modulator (SLM) or a deformable mirror array (DMA) configured to modulate the light;
capturing, by the one or more sensors, an image of the target as illuminated by the modulated light;
generating a simulated image by a differential model;
comparing the captured image with the simulated image;
estimating the target, aberration, and phase delay based on back-propagation of the comparison; and
correcting for the aberration based on at least one of the estimated target, the aberration, or the phase delay.

12. The computer-implemented method of claim 11, wherein the differential model includes:
a neural object representation configured to predict an intensity of the object; and
a neural aberration representation configured to predict the aberration.

13. The computer-implemented method of claim 12, further comprising:
predicting the intensity of the object by the neural object representation by:
predicting a displacement vector (Δx, Δy) by a first multilayer perceptron network based on a time-dependent observation (x, y, t);
projecting a canonical space feature (x+Δx, y+Δy) on a neural texture map based on the displacement vector;
sampling the neural texture map at (x+Δx, y+Δy) to obtain a multi-dimensional vector representing the spatial feature of the canonical coordinate (x+Δx, y+Δy); and
predicting, by a second multilayer perceptron network, the intensity based on the multi-dimensional vector for each coordinate.

14. The computer-implemented method of claim 12, further comprising:
predicting the aberration based on input coordinates (u, v, t) by:
transforming spatial coordinates (u, v) with N_{Z} Zernike basis functions and then concatenated with t; and
predicting the aberration by a third multilayer perceptron network based on the transformed input.

15. The computer-implemented method of claim 11, wherein the optical aberration includes a dynamic aberration.

16. The computer-implemented method of claim 11, further comprising:
generating the modulation based on a series of known and stochastically generated patterns.

17. The computer-implemented method of claim 11, further comprising:
generating the modulation based on a modulation pattern predicted by a neural network.

18. The computer-implemented method of claim 17, further comprising:
optimizing the modulation pattern based on a model parameterized by the neural network.

19. The computer-implemented method of claim 11, wherein the modulation includes a random generation of patterns.

20. A non-transitory computer-readable medium having stored thereon a program that, upon being executed by a processor, causes the processor to execute a computer-implemented method for imaging through an obscurant, the method comprising:
capturing an image of a target by one or more sensors;
incoherently illuminating a target by a light, wherein the obscurant scatters the light creating an optical aberration;
modulating the scattered light by a spatial light modulator (SLM) or a deformable mirror array (DMA) configured to modulate the light;
capturing, by the one or more sensors, an image of the target as illuminated by the modulated light;
generating a simulated image by a differential model;
comparing the captured image with the simulated image;
estimating the target, aberration, and phase delay based on back-propagation of the comparison; and
correcting for the aberration based on at least one of the estimated target, the aberration, or the phase delay.
